(19) United States
(12) Patent Application Publication
(10) Pub. No.: US 2018/0036639 A1
(43) Pub. Date: Feb. 8, 2018

(54) STORY-DRIVEN GAME CREATION AND PUBLICATION SYSTEM

(71) Applicant: MetaArcade, Inc., Mercer Island, WA (US)

(72) Inventors: David Moureau Reid, Mercer Island, WA (US); Gregory John Buron, Renton, WA (US); Marc Anthony Racine, Renton, WA (US); Chad Jeremy Riddle, Newberg, OR (US)

(21) Appl. No.: 15/668,180

(22) Filed: Aug. 3, 2017

Related U.S. Application Data
(60) Provisional application No. 62/371,552, filed on Aug. 5, 2016.

(51) Int. Cl. A63F 13/60; A63F 13/52; A63F 13/30; A63F 13/47

(52) U.S. Cl. CPC A63F 13/60; A63F 13/47; A63F 13/52; A63F 13/30; A63F 2300/6009

(57) ABSTRACT

A system for creating and publishing story-driven games can provide various user interfaces which enable one or more game creators to construct frames, input story narratives, incorporate third-party multimedia content, configure deterministic and/or non-deterministic transitioning between frames, compile and publish games to multiple game marketplaces.

### CROSS-REFERENCE TO RELATED APPLICATION(S)

This application claims the benefit of U.S. Provisional Patent Application No. 62/371,552 filed on Aug. 5, 2016, entitled “SOFTWARE PLATFORM ENABLING CREATION AND SELF-PUBLISHING OF STORY-DRIVEN GAMES FOR COMPUTERS AND MOBILE DEVICES,” which is incorporated herein by reference in its entirety.

### BACKGROUND

Story-driven games, such as adventure games, generally refer to a category of video or computer games in which a player assumes a role in an interactive story involving exploration, puzzle-solving, battling, or other actions. Story-driven games can be modeled after narrative-based media such as literature and movies.

### BRIEF DESCRIPTION OF THE DRAWINGS

FIG. 1 illustrates a networked environment that includes a game creation system for creating and publishing story-driven games, in accordance with some embodiments of the presently disclosed technology.

FIG. 2 illustrates components of the game creation system in accordance with some embodiments of the presently disclosed technology.

FIGS. 3A-3C illustrate the logical branching of game storyline, a user interface for constructing a frame of the game, and the presentation of the frame within an executable game, in accordance with some embodiments of the presently disclosed technology.

FIG. 4 is a flowchart illustrating a process for creating and publishing a story-driven game in accordance with some embodiments of the presently disclosed technology.

FIGS. 5-13 illustrates various user interfaces implemented in accordance with some embodiments of the presently disclosed technology.

FIG. 14 is a block diagram illustrating an example of the architecture for a computer system or device that can be utilized to implement various functionalities in the networked environment of FIG. 1.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

The ever-expanding scope of the Internet and the proliferation of network-connected computing devices have enabled millions of people to share stories or other creative content. However, most writers lack the technical skills to turn their words into fully fledged, interactive story-driven games. Typically, game creation systems are not designed from the perspective of a writer, who likely prefers to focus primarily on the narrative of storylines and may lack other game building skills. Typically, professional art creation and computer programming are required to create and publish story-driven games. For example, a typical game creation system may require a game creator to build art and other assets, and may require the game creator to have programming skills such as code or script writing. Writers who want to turn their narrative into games need to collaborate with or hire artists, audio designers, engineers, programmers, and/or other professionals. This process can introduce high cost, communication error, development inefficiency, and other adverse factors that can discourage many creative minds.

The system disclosed herein provides user interfaces that enable writers to input narratives that drive the storyline of games, obtain visual content (e.g., still images, animation, or video), audio content (e.g., music or sound effects), or other multimedia content to accompany the narratives, straightforwardly specify development and/or branching of storyline without code or script programming, concretely examine the logical flow of a game as it is being built, and self-publish an executable game to various digital marketplaces for access to game consumers. In short, the presently disclosed technology enables anyone who can write a story to make and publish a story-driven game with art, audio, and/or an embedded rules engine, without technical or artistic skills required. The system can also enable the establishment of a content marketplace where content contributors can upload multimedia content for incorporation into story-driven games and for sharing profits with game creators.

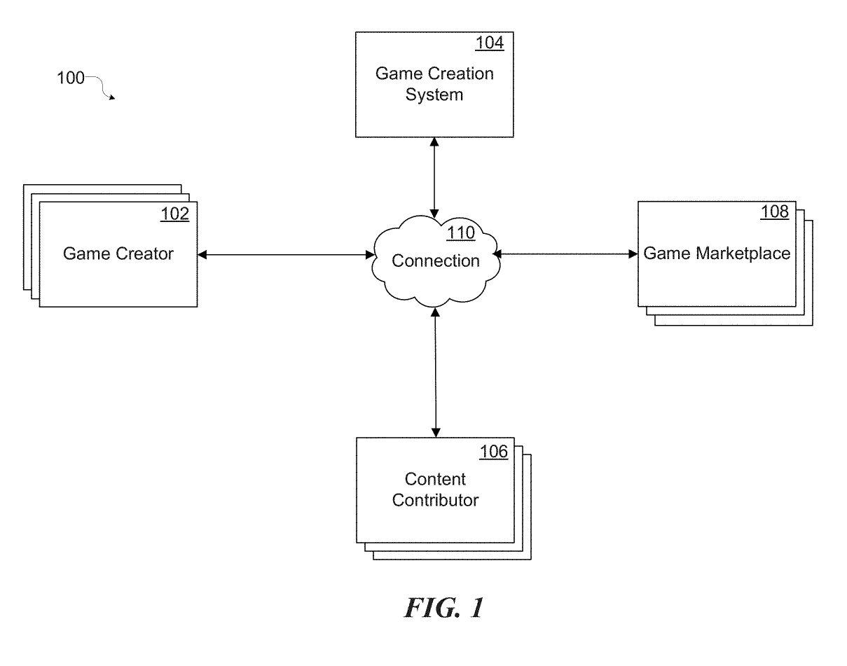

FIGS. 1-14 are provided to illustrate representative embodiments of the presently disclosed technology. Unless provided for otherwise, the drawings are not intended to limit the scope of the claims in the present application.

Many embodiments of the technology described below may take the form of computer-executable instructions, including routines executed by one or more programmable computers or controllers. Those skilled in the relevant art will appreciate that the technology can be practiced on computer systems other than those shown and described below. For example, the technology can be embodied in one or more special-purpose computers or data processors that are specifically programmed, configured or constructed to perform one or more of the computer-executable instructions described below. As another example, at least some portion of the technology can be implemented by virtual machines provided by networked computing resources (commonly referred to as cloud computing resources). Accordingly, the terms “computer,” “computer system,” or “computing device” as generally used herein refer to any data processor and can include Internet appliances and mobile devices (including palm-top computers, wearable computing devices, cellular or mobile phones, multi-processor systems, processor-based or programmable consumer electronics, network computers, mini computers, tablet computers, smart televisions, video game consoles, augmented reality (AR) and virtual reality (VR) devices, and the like). Information handled by these computers, computer systems, or computing devices can be presented at any suitable display medium, including an LCD (liquid crystal display). Instructions for performing computer-executable tasks can be stored in or on any suitable computer-readable medium, including hardware, firmware or a combination of hardware and firmware. Instructions can be contained in any suitable memory device, including, for example, a flash drive, USB (universal serial bus) device, and/or other suitable medium.

FIG. 1 illustrates a networked environment 100 that includes a game creation system 104 for creating and publishing story-driven games, in accordance with some embodiments of the presently disclosed technology. As illustrated in FIG. 1, the environment 100 includes one or more game creators 102, the game creation system 104, one or more content contributors 106, and one or more game marketplaces 108 that are communicatively connected with one another via connections 110. The connections 110 can include any combination of local area and/or wide area networks, using both wired and wireless communication systems. In some embodiments, the connections 110 use standard communications technologies and/or protocols. Thus, the connections 110 can include links using technologies such as Ethernet, 802.11, worldwide interoperability for microwave access (WiMAX), 3G, 4G, CDMA, digital subscriber line (DSL), etc. The networking protocols used can include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the connections 110 can be represented using technologies and/or formats including hypertext markup language (HTML) or extensible markup language (XML). In addition, all or some of the links can be encrypted using conventional encryption technologies such as secure sockets layer (SSL), transport layer security (TLS), and Internet Protocol security (IPsec).

The game creators 102 include narrative writers or storyline authors of a game. The game creators 102 use associated computing devices (e.g., workstations, personal computers, palm-top computers, smartphones, tablet computers, or the like) to access the game creation system 104 via connections 110. In some embodiments, the associated computing devices implement dedicated front end software or generic user interface software (e.g., web browsers) for presenting user interfaces generated by the game creation system 104, receiving user inputs and interactions via the presented user interfaces, and communicating the interactive data with the game creation system 104. Illustratively, one or more game creators 102 can use the user interfaces to write narratives for multiple frames of a game, and map out the game's storyline with multiple branches and/or outcomes. The multiple branches and/or outcomes can be deterministic (e.g., based on explicit choices of the player) or non-deterministic (e.g., including a level of randomness based on various attributes associated with the player, the frame, and/or the storyline development history). In some embodiments, for each interactive element of the game (e.g., a player's choice from a range of options such as fight or flee from an enemy, selecting one of several possible paths in an intersection of corridors, or the like), the game creator 102 uses the user interfaces to browse and search various multimedia content repositories for applicable content, and incorporate them to add more narrative depth and ambience to the element. In some embodiments, the game creator 102 requests content contributors 106 to submit candidate multimedia content through the game creation system 104 for specific frames and/or elements.

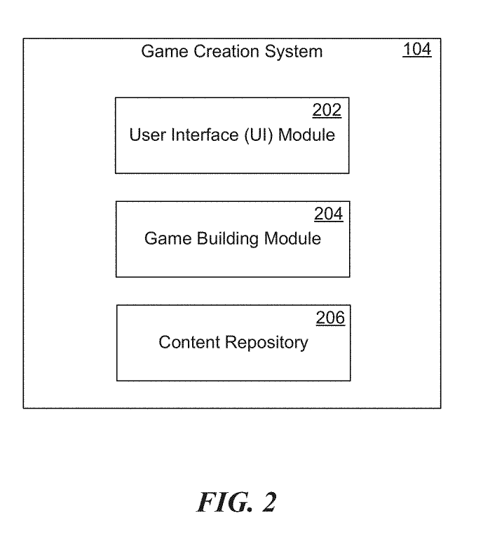

As will be discussed in further detail below with reference to FIG. 2, the game creation system 104 can include multiple components implemented on one or more computing devices. In some embodiments, the game creation system 104 generates user interfaces, processes user input or interaction data, maintains (e.g., store, classify, facilitate search and retrieval, or the like) multimedia content data, compiles or otherwise builds games to become computer-executable software, publishes executable games to game marketplaces, processes accounting and compensation for multiple parties, and/or performs other functionalities in accordance with the presently disclosed technology.

In various embodiments, the content contributors 106 include painters, sketchers, digital artists, musicians, audio engineers, or other professionals or amateurs who can provide multimedia content for incorporation into games. The content contributors 106 can use associated computing devices (e.g., workstations, personal computers, palm-top computers, smartphones, or the like) to access the game creation system 104 via connections 110. Illustratively, the content contributors 106 can upload multimedia content as well as associated metadata (e.g., keywords, subject, description, restrictions on use or compensation, or the like) to the game creation system 104. In some embodiments, the system enables the content contributors 106 to upload content in response to specific content requests as discussed above.

In various embodiments, the game marketplaces 108 include network-based software or app stores such as Apple App Store, Google Play, Steam, Amazon, or the like. Once the game creator 102 completes the creation of a game with various frames, the game creation system 104 can compile the game into one or more executable software suitable for distribution via one or more game marketplaces 108. Once consumers purchase, play, or otherwise access the game in accordance with a particular game marketplace system, the game marketplace 108 can further communicate accounting and compensation data with the game creation system 104.

FIG. 2 illustrates components of the game creation system 104 in accordance with some embodiments of the presently disclosed technology. As illustrated in FIG. 2, the game creation system 104 includes a user interface (UI) module 202, a game building module 204, and a content repository 206. In some embodiments, The UI module 202 is implemented as software executed by one or more computing devices for generating various user interfaces to facilitate frame construction, narrative input, content selection and/or requesting, storyline branching, game marketplace selection, game publication, content uploading, or other related functionalities as disclosed herein. The UI module 202 can communicate data with the game creator(s) 102 and/or content contributor(s) 106 via the connections 110, cause generated user interfaces to be presented and updated, and process user interactions received from the game creator(s) 102 and/or content contributor(s) 106.

In some embodiments, the game building module 204 is implemented as software executed on one or more computing devices for communicating with the UI module 202 (e.g., exchanging game configuration and content data), compiling game into executable software in accordance with various game marketplace specifications or standards, communicating with the game marketplace(s) 108 to publish the executable games, or other related functionalities as disclosed herein. In some embodiments, at least some portion of the game building module 204 and some portion of the UI module 202 are implemented by different computing devices or systems. In some embodiments, the game building module 204 and UI module 202 correspond to a same software component of the game creation system 104.

In some embodiments, the game building module 204 implements one or more embedded rules engines, game player user interface schemes or templates, and/or other settings that are predefined based on various themes or contexts (e.g., derived from literature, movies, or other licensed material). These settings enable different look and feel, dynamics, or other game player experience for different games to be created. For example, each set of settings can be associated a distinct set of art, audio, monsters, treasures, and/or other content assets appropriate for a particular theme or context (e.g., “Star Wars Adventures,” “Harry Potter Adventures,” “Tunnels and Trolls Adventures,” etc.) Similarly, each set of setting can include a distinct rule set (e.g., implemented as a specific embedded rules engine) for adjudicating combat, saving rolls, or other non-deterministic events in accordance with the particular theme or context. Additionally, each set of settings can be associated with a distinct set of game player user interface scheme or templates (e.g., distinct colors, fonts, button shapes, button functions, button placements, combinations of the same or the like). With these different settings, a game creator can create one or more interactive story-driven games, each associated with a distinct look and feel, dynamics, and/or other game player experience in accordance with a corresponding theme or context.

In some embodiments, the content repository 206 includes one or more databases or data stores implemented on any type of computer-readable media that can store data accessible by the UI module 202, game building module 204, and/or other game creation system components (not shown). Such computer-readable media can include, for example, magnetic hard and floppy disk drives, optical disk drives, magnetic cassettes, tape drives, flash memory cards, digital video disks (DVDs), Bernoulli cartridges, RAM, ROM, smart cards, etc. In some embodiments, at least some portion of the content repository 206 can be implemented via network-based data storage (commonly referred to as cloud storage). The content repository 206 can be configured to support searching, classifying, clustering, sorting, prioritizing, filtering, or otherwise organizing the multimedia content uploaded by the content contributor(s) 106 based, for example, on metadata associated with the content or an analysis of the content.

In some embodiments, the game creation system 104 further includes an application programming interface (API) request module, a web server module, network interfaces, security mechanisms, load balancers, failover servers, management and network operations consoles, or additional, fewer, or different modules for various applications. These possible components are not shown so as to not obscure the details of the system.

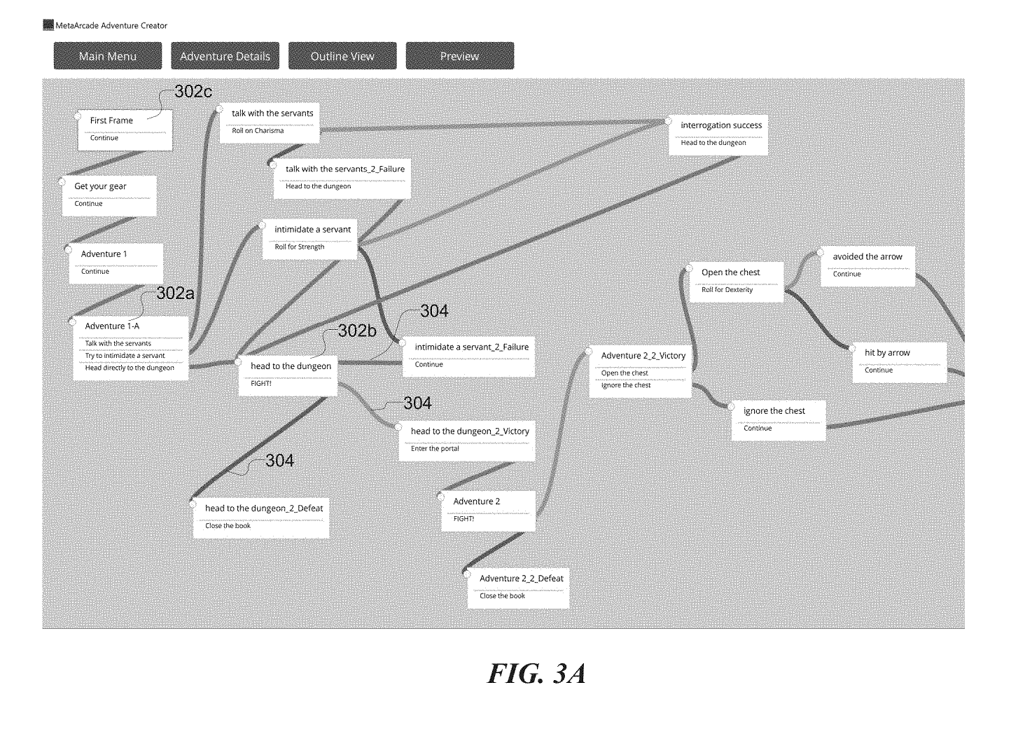

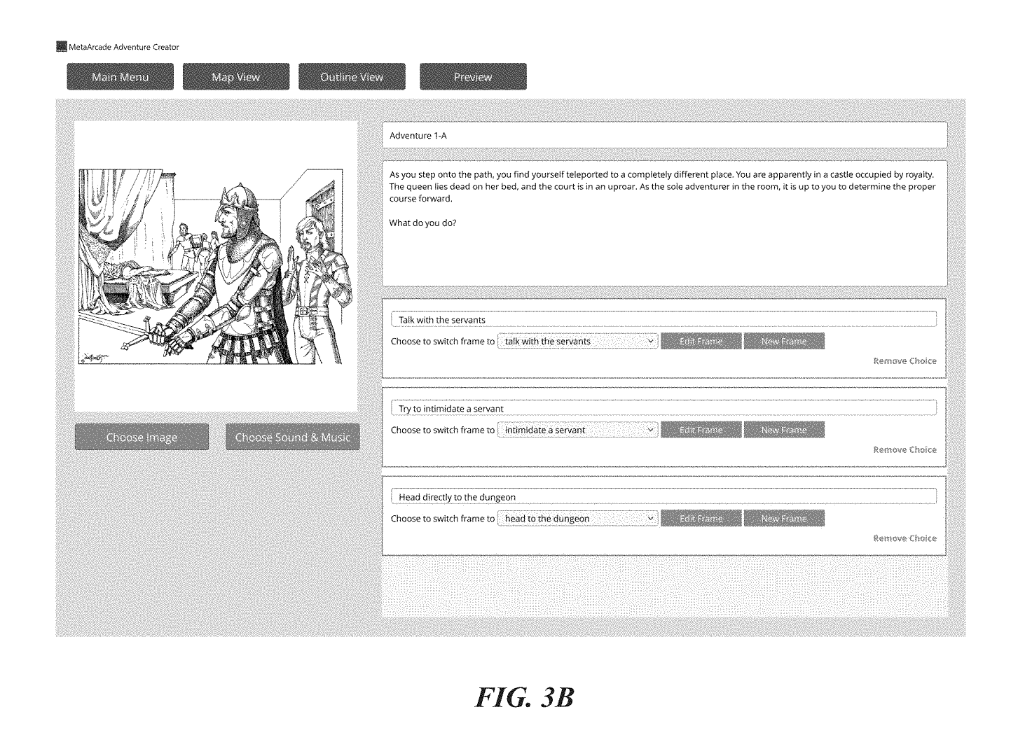

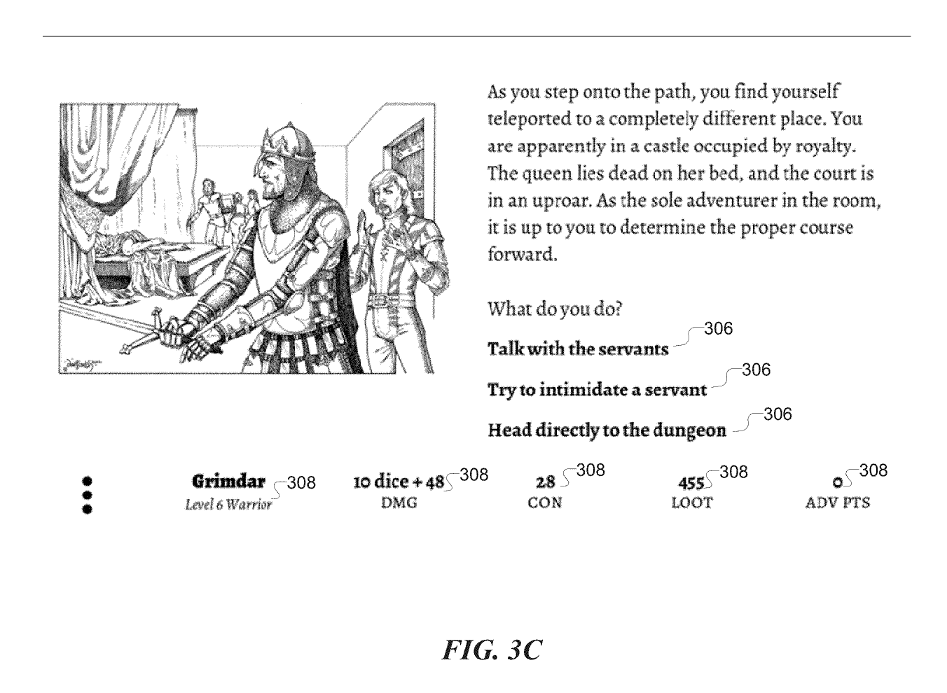

FIG. 3A illustrates the logical branching of a game storyline including multiple frames in accordance with some embodiments of the presently disclosed technology; FIG. 3B illustrates a user interface for constructing a frame in accordance with some embodiments of the presently disclosed technology; and FIG. 3C shows presentation of the frame of FIG. 3B within an executable game, in accordance with some embodiments of the presently disclosed technology.

With reference to FIG. 3A, the storyline of a story-driven game includes multiple frames (e.g., frames 302a-302c) that are connected with one another by directed links 304, which branch based on logic or rules specified by the game creator(s) 102. As will be discussed in further detail below, the logic or rules can be deterministic (e.g., based directly on explicit choices of the player, in a manner that is consistent across multiple game executions in which the same explicit player choices are made) or non-deterministic (e.g., including a level of randomness based on various attributes associated with the player, the frame, and/or the storyline development while the game is played, in a manner that can vary across multiple game executions in which the same explicit player choices are made).

With reference to FIG. 3B, the system disclosed herein provides a user interface for constructing frames. Illustratively, the user interface of FIG. 3B corresponds to a user interface for constructing frame 302a in the storyline of FIG. 3A. As will be discussed in further detail below, the user interface can facilitate straightforward, natural language based input of logics or rules for storyline branching (i.e., dropdown menus for condition setting and/or destination frame(s) selection) without the need for any code or script writing.

As will be discussed in further detail below, the system can compile a game including multiple frames into executable software. FIG. 3C shows presentation of the frame (e.g., corresponding to frame 302a of FIG. 3A) constructed using the interface of FIG. 3B when the executable game is played on a computing device (e.g., a smart phone, tablet, or laptop computer). Illustratively, the lower portion of the display shows storyline branching choices 306 and various player attributes 308.

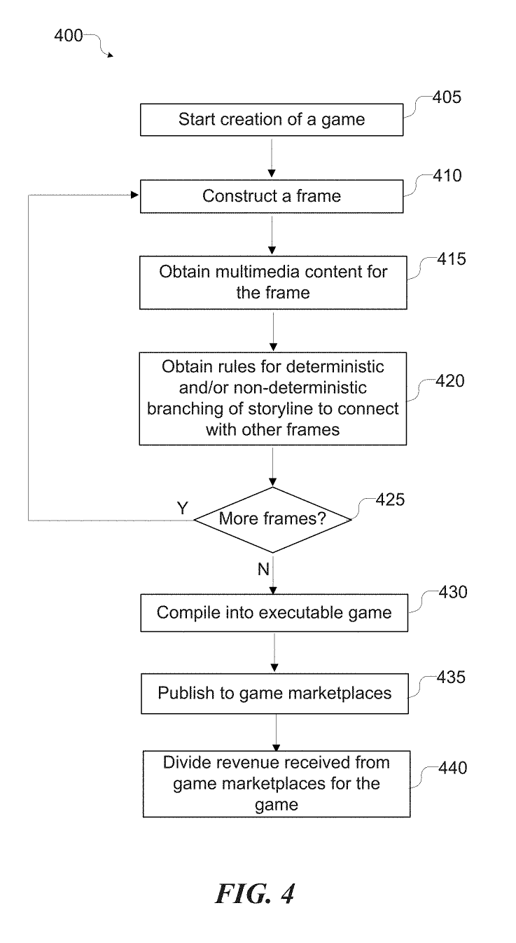

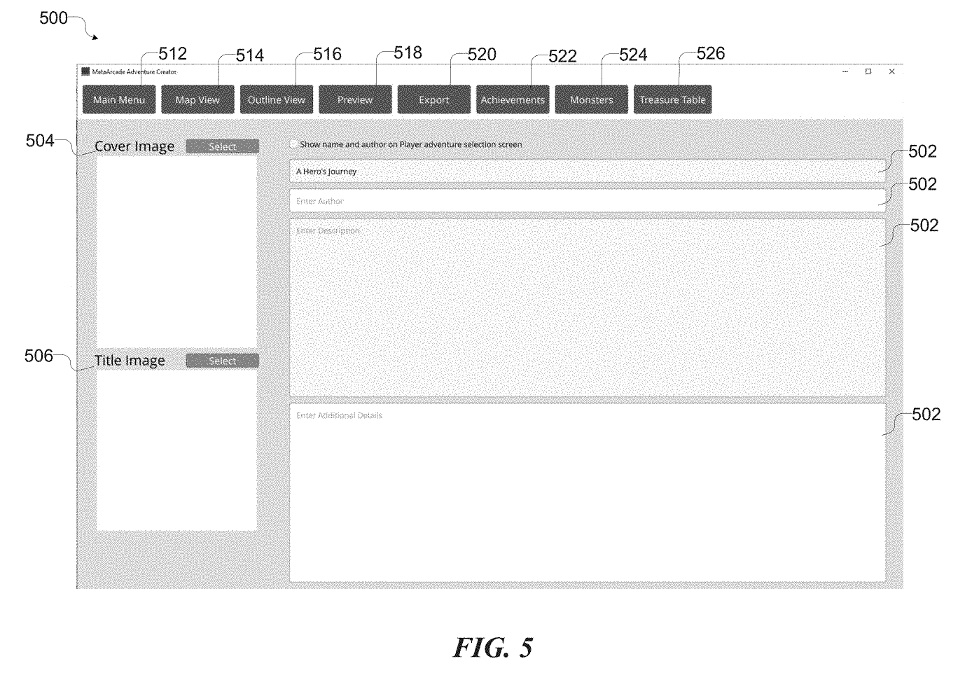

FIG. 4 is a flowchart illustrating a process 400 for creating and publishing a story-driven game in accordance with some embodiments of the presently disclosed technology. Illustratively, the process 400 can be implemented by the game creation system 104. At block 405, the game creation system 104 starts creation of a game. Illustratively, game creation is triggered by an interaction (e.g., selecting a “creating a new game” button) with the game creation system 104 by a game creator 102. In response to the user interaction, the game creation system 104 generates and causes presentation of a user interface (e.g., user interface 500 as illustrated in FIG. 5) to the game creator 102 via an associated computing device. For example, the user interface can include one or more text boxes (e.g., text boxes 502 as illustrated in FIG. 5) for the game creator 102 to enter, in natural language, information about the author, the story to be created, or other game related aspects. The user interface can also facilitate selection of multimedia content, such as images for cover and title, for example, via selection areas 504 and 506 as illustrated in FIG. 5. In some embodiments, the user interface enables selection of one or more settings (e.g., selection of content asset set, rules engine, and/or game player user interface scheme) for the game, for example, via one or more drop-down menus.

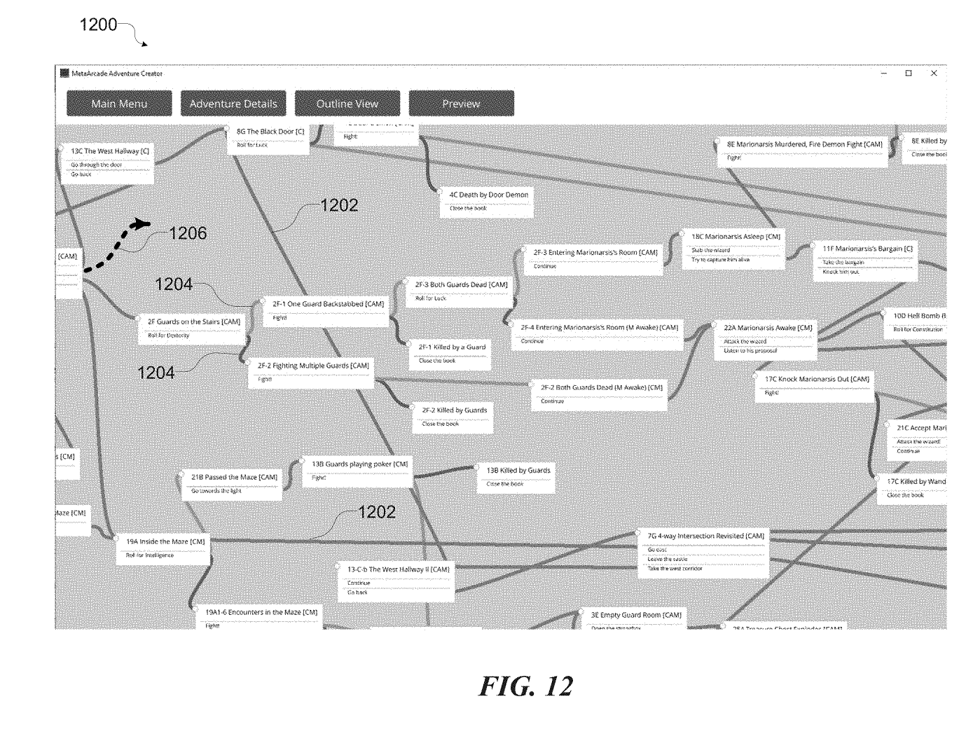

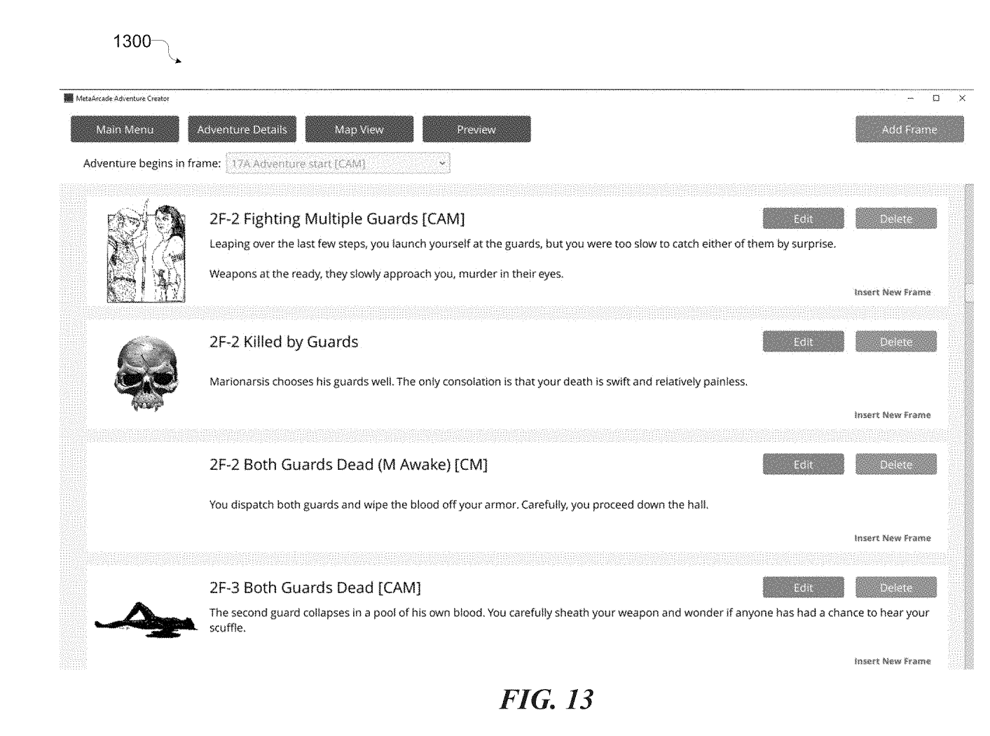

In some embodiments, the user interface also facilitates switching to other functionalities of the game creation system 104. For example, with reference to FIG. 5, in response to a selection of a “Main Menu” button 512, the game creation system 104 generates and causes presentation of a user interface for overall functional control of the system; in response to a selection of a “Map View” button 514, the game creation system 104 generates and causes presentation of a user interface (e.g., the user interface illustrated in FIG. 3A or FIG. 12) for a map-styled overview of various frames and their interconnections that are currently included in the game; in response to a selection of an “Outline View” button 516, the game creation system 104 generates and causes presentation of a user interface (e.g., the user interface illustrated in FIG. 13) for an outline-styled overview of various frames currently included in the game; in response to a selection of a “Preview” button 518, the game creation system 104 generates and causes presentation of a preview (e.g., in a form that will be present to a game player when a corresponding executable game is played) of the game feature or portion current being edited (e.g., cover, title, frame, etc.); in response to a selection of an “Export” button 520, the game creation system 104 generates a data file including all the game information (e.g., including frames, connections, configuration, features, selected art and audio assets, etc.) for saving to a local or network-based data storage; and in response to a selection of an “Achievements” button 522, “Monsters” button 524, or “Treasure Table” button 526, 104 generates and causes presentation of a user interface for editing various features, attributes and/or elements of the game. At least some of the above mentioned buttons are also included in other applicable user interfaces described herein.

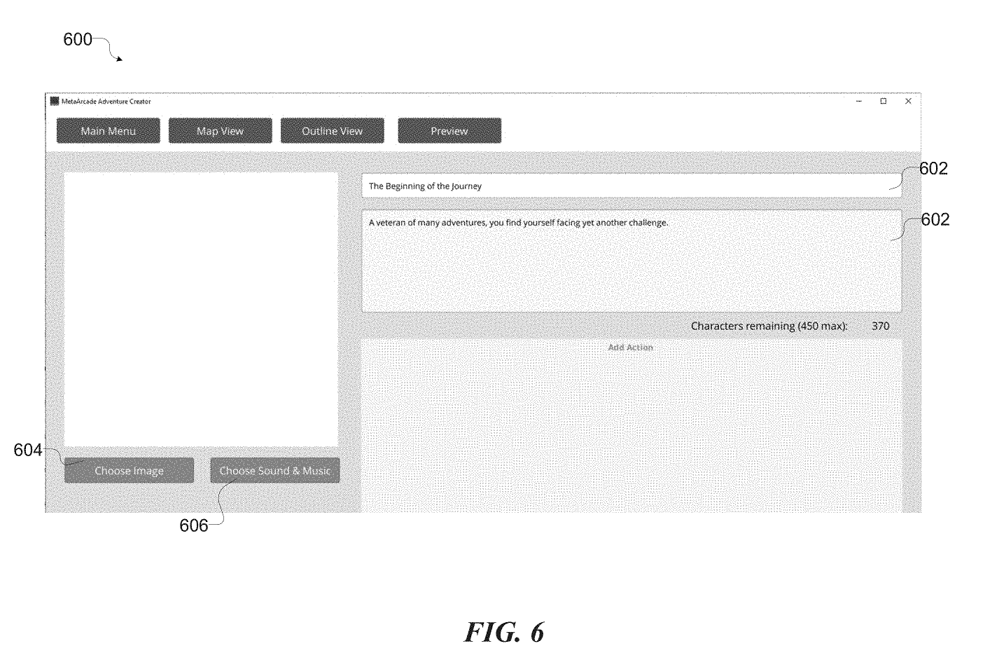

At block 410, the game creation system 104 constructs a frame for the game. Illustratively, in response to the game creator 102's interaction (e.g., selecting a “new frame” or “add frame” button) with a user interface, the game creation system 104 generates and causes presentation of a user interface (e.g., user interface 600 as illustrated in FIG. 6) to the game creator 102 via an associated computing device. For example, the user interface can include one or more text boxes (e.g., text boxes 602 as illustrated in FIG. 6) for the game creator 102 to enter, in natural language, title, narratives, or other story text specific to the frame.

At block 415, the game creation system 104 obtains multimedia content for the frame. Illustratively, the user interface presented at block 410 can also facilitate selection of multimedia content, such as images and audio, from the content repository 206, to be included in the frame. As previously discussed, each third party content contributor 106 whose multimedia content is selected for inclusion in the game can receive proceeds when the game publishes and generates sales revenue.

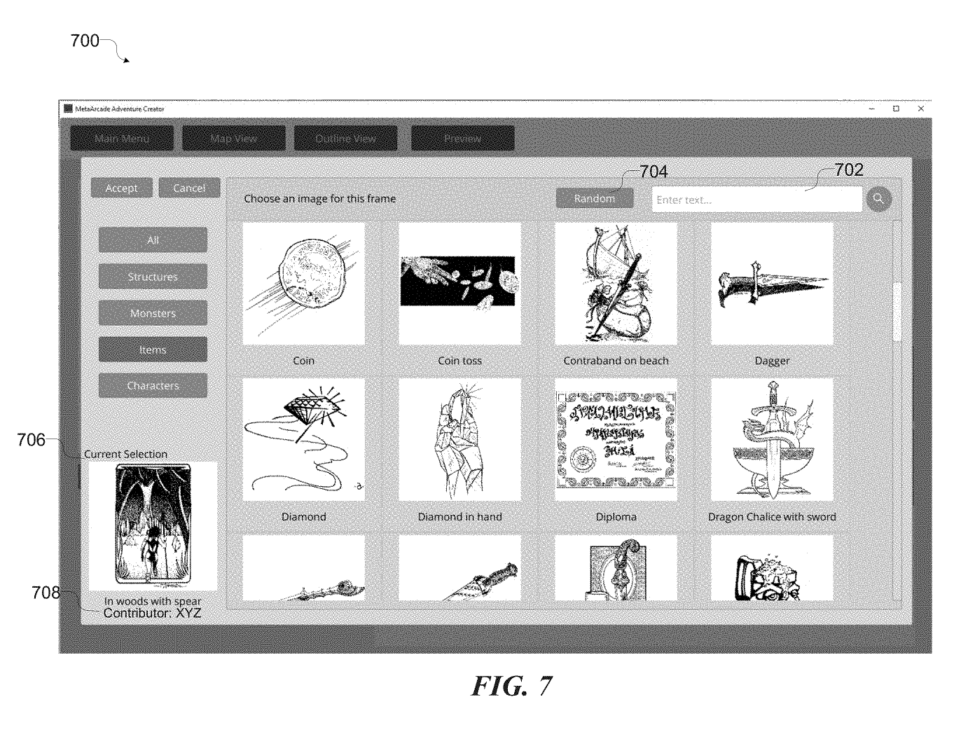

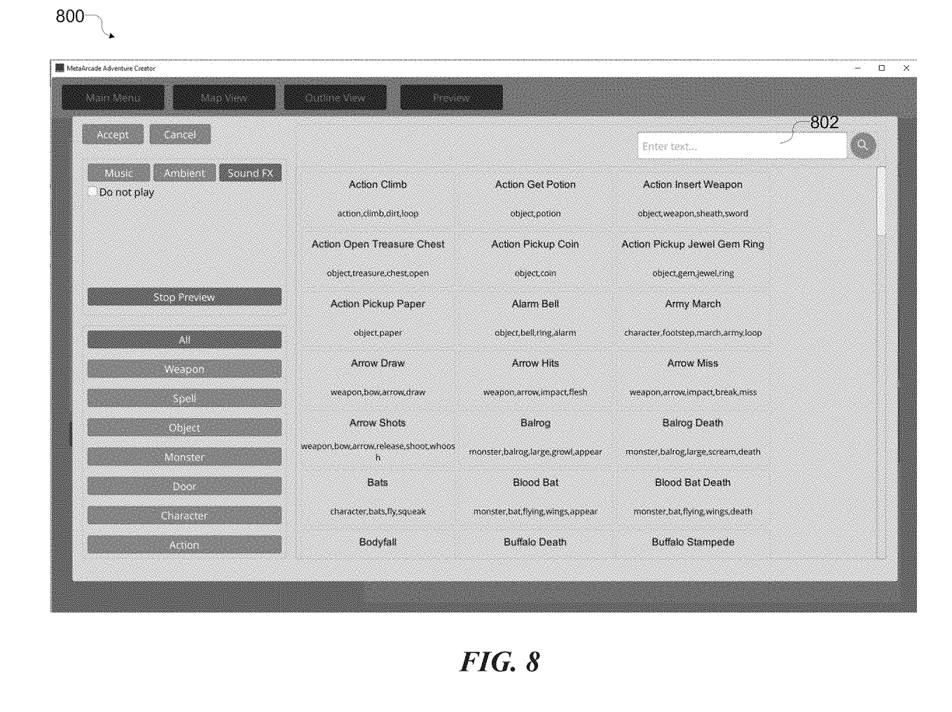

More specifically, in response to the game creator 102's interaction (e.g., selecting a “choose image” button 604 or “choose sound & music” button 606 as illustrated in FIG. 6) with the user interface for selection of a type of content, the game creation system 104 can generate and cause presentation of another user interface (e.g., user interface 700 as illustrated in FIG. 7 or user interface 800 as illustrated in FIG. 8) to the game creator 102 via an associated computing device.

Illustratively, via user interface 700, a game creator 102 can browse through one or more image archives maintained by the content repository 206, use a search bar 702 to find a specific image, or click a “random” button 704 to select an image at random. Each frame can accommodate one or more images. The images can be black-and-white, grayscale, or colored. In some embodiments, the game creation system 104 can automatically analyze the narratives of the frame or other associated story text and search the image archive(s) for a selected set of images that are likely to fit into the frame. For example, the game creation system 104 can perform keyword based matching between frame narratives and applicable information included in image metadata. The game creation system 104 can sort or order the images in the selected set based on a measurement of the match and present the ordered image set to the game creator 102 via the user interface 700. In response to a selection made by the game creator 102, the selected image can be displayed in a “Current Selection” area 706 with contributor identification information 708, and/or use restrictions or other information derived from associated metadata.

Illustratively, via user interface 800, a game creator 102 can browse through one or more audio archives maintained by the content repository 206, and/or use a search bar 802 to find one or more pieces of audio content. Audio content can be classified, for example, into music tracks, ambient tracks, and sound effects via the user interface 800. Music tracks can correspond to musical scores for overall tone (e.g., suspenseful, celebratory, etc.), ambient tracks can reflect the specific environment of the frame (e.g., a loud tavern, inside a cave, alongside a river, etc.), and sound effects can be used for specific moments in an adventure (e.g., a monster's roar, a weapon striking, footsteps, etc.) The user interface 800 further enables the game creator 102 to “preview” the audio content prior to choosing one or more pieces for the frame. In some embodiments, the game creation system 104 can automatically analyze the narratives of the frame or other associated story text and search the audio archive(s) for a selected set of audio content that are likely to fit into the frame. For example, the game creation system 104 can perform keyword based matching between frame narratives and applicable information included in the audio content metadata. The game creation system 104 can sort or order the audio content in the selected set based on a measurement of the match and present the ordered audio set to the game creator 102 via user interface 800.

In some embodiments, the game creator 102 can request all or a selected group of content contributors 106 to submit candidate multimedia content for the frame, using the game creation system 104. Illustratively, in response to a game creator 102's request, the game creation system 104 can send information regarding the frame (e.g., narratives) to the content contributors 106, or allow the content contributors 106 limited access (e.g., read-only) to the current frame and possibly one or more connected frames in the storyline. The content contributor(s) 106 can in turn submit candidate content for the frame within a prescribed time period for selection by the game creator 102.

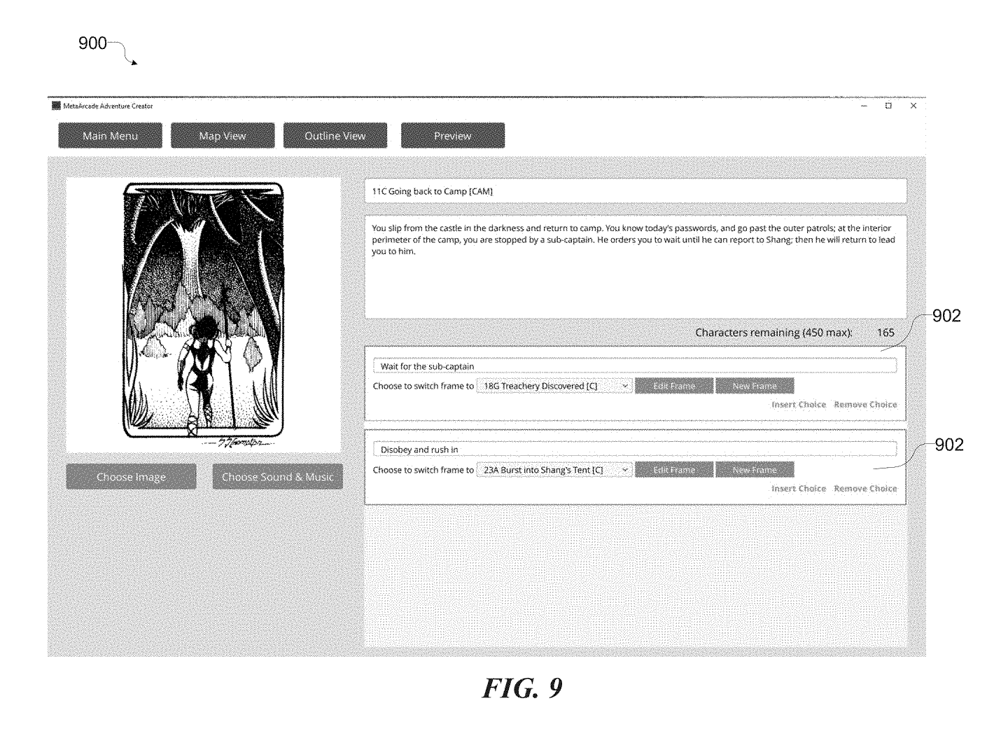

At block 420, the game creation system 104 obtains rules for deterministic and/or non-deterministic branching of storyline that connects the current frame to other frame(s). As discussed above, transitioning from the current frame to another frame can be deterministic (e.g., where the choice of a next frame to proceed to is made by the player of the game based on a storyline predetermined by the game creator 102). Illustratively, the game creation system 104 can generate and cause presentation of a user interface (e.g., user interface 900 as illustrated in FIG. 9) to the game creator 102 via an associated computing device. The user interface enables the game creator 102 to create deterministic branching via one or more choice inputs (e.g., choice inputs 902 of user interface 900).

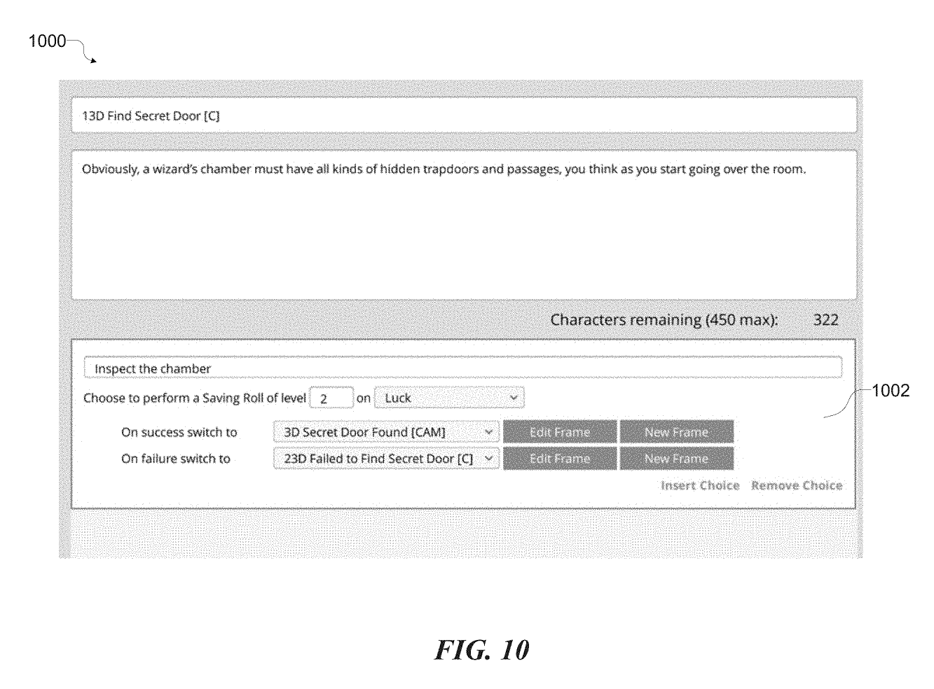

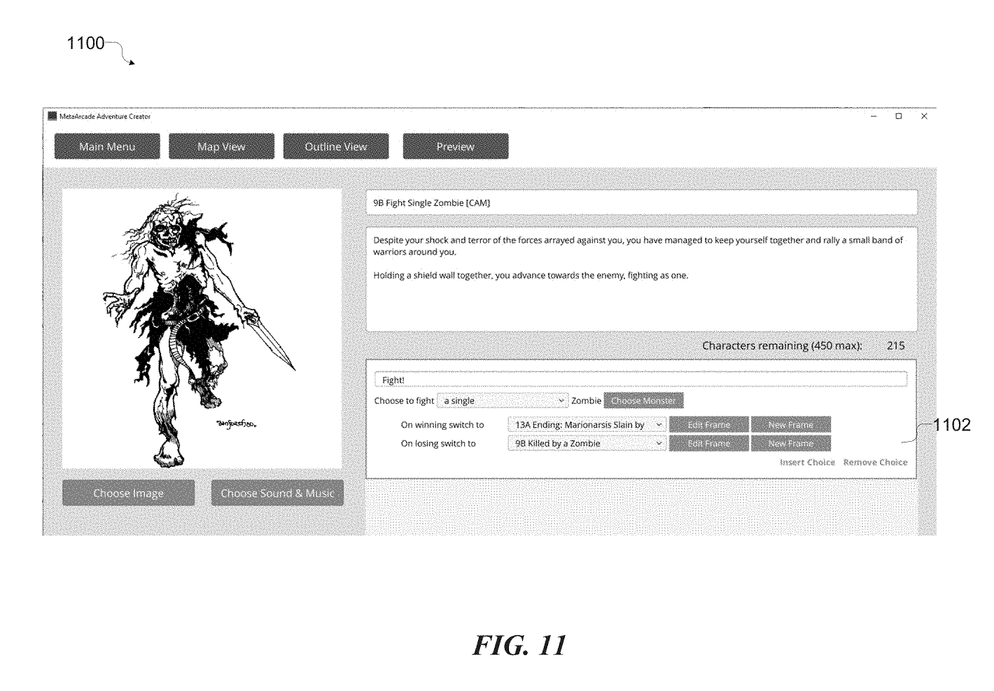

As discussed above, transitioning from the current frame to another frame can be non-deterministic (e.g., based on the outcome of random number generation for game mechanics such as combat or saving rolls). In some embodiments, the non-deterministic randomness is implemented via one or more computer-simulated dice-rolls, spinners, coin-flips, combination of the same or the like. Illustratively, the game creation system 104 can generate and cause presentation of a user interface (e.g., user interface 1000 for branching via a “saving roll” as illustrated in FIG. 10 or user interface 1100 for branching via “combat” as illustrated in FIG. 11) to the game creator 102 via an associated computing device. The user interface enables the game creator 102 to create non-deterministic branching via one or more conditional inputs (e.g., conditional input 1002 of user interface 1000 or conditional input 1102 of user interface 1100).

The conditional inputs can include one or more text input areas where the game creator 102 can describe the context or other related information of a non-deterministic branching. The conditional inputs can also include various straightforward, natural language based input areas for the game creator 102 to set rules for the non-deterministic branching. For example, the game creator 102 can set rules, such as “if the player has the gold key, then the gold door can be opened; otherwise the gold door cannot be opened,” “if the player has a rope, they can tie the rope and climb down into a pit; otherwise they cannot;” and “if the player has an attribute value higher than X, they can use a particular item A; if the attribute value is between X and Y (Y lower than X), they can use a particular item B; if the attribute value is lower than Y, they cannot use any of the particular items.” In other words, the rules can include evaluation (e.g., numerical and/or Boolean based) of one or more attribute values associated or unassociated with a player or a group of players (e.g., one or more players' level, equipment, power, collection, energy, and/or other attributes), the type or nature of the current frame (e.g., whether the current frame advances or impedes the player, whether the current frame is informational or investigatory, etc.), the type or nature of frames that the player(s) has visited within a recent period of time (e.g., a percentage of deterministic and/or non-deterministic frames that the player visited during the past hour, a ratio between advancing and impeding frames that the player visited during the past week, etc.), combination of the same or the like, which can be weighted or otherwise associated with one or more randomly generated numbers, and then compared to one or more threshold values for branching into multiple existing or new frames based on the comparison(s).

At block 425, the game creation system 104 determines whether more frames need to be constructed. Illustratively, the game creation system 104 can generate and cause presentation of a user interface (e.g., user interface 1200 as illustrated in FIG. 12) to the game creator 102 via an associated computing device. The user interface can show some or all of frames currently included in the game and their inter-connections (deterministic and/or non-deterministic), for example, as a network or map of nodes and directed edges. Illustratively, different colors and/or shapes of the edges can be used to indicate a deterministic path 1202 (e.g., magenta colored straight line indicating a path where the player makes a choice and progresses to a frame which the game creator 102 has pre-determined) or different types of non-deterministic paths (e.g., green curved line indicating a path where the player has successfully overcome a challenge such as a combat, saving roll, coin flip, etc., or red curved line indicating a path where the player has failed to overcome a challenge). In some embodiments, the user interface shows edge(s) (e.g., dashed line edge 1206), whether a deterministic or non-deterministic type, that is only connected to one existing frame, which means that a destination frame for the edge has not been constructed. In these embodiments, the game creation system 104 can prompt the game creator 102 to construct the destination frame. In some embodiments, another user interface (e.g., user interface 1300 as illustrated in FIG. 13) can be generated and presented to enable the game creator 102 to view or edit some or all of frames currently included in the game.

If more frames need to be constructed, the process 400 proceeds to block 410. Otherwise, the process 400 proceeds to block 430. Illustratively, the game creator 102 can signal or indicate to the game creation system 104 that all frames for the game have been completed (e.g., by clicking a “complete” or “compile” button via a user interface). If the game creation system 104 determines that no additional frames need to be constructed, the process 400 proceeds to block 430 where the game creation system 104 compiles the game into one or more executable software in accordance with the specification or standard of one or more pre-selected game marketplaces 108. In some embodiments, the non-compiled and/or compiled game can be exported to a local save file, and/or to a cloud storage.

At block 435, the game creation system 104 proceeds to communicate with the pre-selected game marketplace(s) 108 and publish the executable game software, with or without additional interactions with the game creator 102. At block 440, the game creation system 104 divides revenue received from the game marketplace(s) 108 for the game. Illustratively, the game creation system 104 performs accounting of the revenue, calculates shares for the game creator(s) 102 who created one or more frames of the game, content contributor(s) 106 whose work were incorporated in one or more frames of the game, and potentially any other parties involved in the creation, compiling, or publishing of the game, in accordance with applicable rules or agreements. The game creation system 104 can then transfer funds (e.g., via electronic payment services such as PayPal) to all relevant parties in accordance with the calculated shares.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

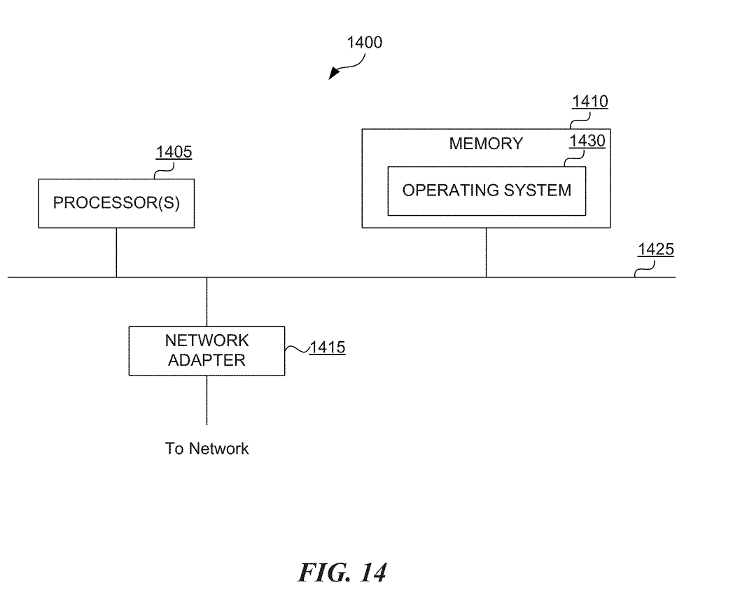

FIG. 14 is a block diagram illustrating an example of the architecture for a computer system or device 1400 that can be utilized to implement various functionalities in the networked environment 100 of FIG. 1. As illustrated in FIG. 14, the computer system 1400 includes one or more processors 1405 and memory 1410 connected via an interconnect 1425. The interconnect 1425 may represent any one or more separate physical buses, point to point connections, or both connected by appropriate bridges, adapters, or controllers. The interconnect 1425, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 1405 may include central processing units (CPUs) to control the overall operation of, for example, the host computer. In certain embodiments, the processor(s) 1405 accomplish this by executing software or firmware stored in memory 1410. The processor(s) 1405 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1410 is or includes the main memory of the computer system. The memory 1410 represents any form of random access memory (RAM), read-only memory (ROM), flash memory (as discussed above), or the like, or a combination of such devices. In use, the memory 1410 may contain, among other things, a set of machine instructions which, when executed by processor 1405, causes the processor 1405 to perform operations to implement embodiments of the presently disclosed technology.

Also connected to the processor(s) 1405 through the interconnect 1425 is a network adapter 1415. The network adapter 1415 provides the computer system 1400 with the ability to communicate with remote devices, such as the storage clients, and/or other storage servers, and may be, for example, an Ethernet adapter or Fiber Channel adapter.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments,” “certain embodiments,” or “some embodiments” means that a particular feature, structure, or characteristic described in connection with the embodiment is included in at least one embodiment of the disclosure. These embodiments, even alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments.

What is claimed is:

1. A computer-implemented method for creation and publication of a story-driven game including a plurality of frames, comprising:
in response to one or more first interactions with a first user interface, configuring a first frame of the plurality of frames to incorporate one or more first pieces of multimedia content;
in response to one or more second interactions with a second user interface, configuring the first frame to be connected to at least two second frames of the plurality of frames in accordance with non-deterministic rules, wherein the one or more second interactions include input of the non-deterministic rules without need for code- or script-based programming;
causing display of a map of the plurality of frames, each connected with at least another frame in accordance with deterministic and/or non-deterministic rules; and
compiling the story-driven game into computer-executable software.

2. The method of claim 1, further comprising configuring the first frame to incorporate textual story narratives specific to the first frame.

3. The method of claim 2, further comprising selecting the one or more first pieces of multimedia content based, at least in part, on the story narratives.

4. The method of claim 3, wherein selecting the one or more first pieces of multimedia content comprises matching the story narratives with metadata associated with the one or more first pieces of multimedia content.

5. The method of claim 1, wherein the multimedia content includes at least one of still images, animations, videos, music, or sound effects.

6. The method of claim 1, wherein the non-deterministic rules are based, at least in part, on applying one or more random numbers to at least one attribute of a game player.

7. The method of claim 6, wherein the non-deterministic rules are further based, at least in part, on the type or nature of the first frame.

8. The method of claim 6, wherein the non-deterministic rules are further based, at least in part, on a comparison with one or more threshold values.

9. The method of claim 1, wherein the deterministic rules are based, at least in part, on at least an explicit choice of a game player.

10. The method of claim 1, wherein the map includes directed edges that connect individual frames, wherein the directed edges are associated with different colors or shapes to indicate corresponding deterministic or non-deterministic rules.

11. A computer-readable medium storing computer-executable instructions that, when executed by one or more processors, cause the one or more processors to perform actions comprising:
causing display of a first user interface for configuring transitioning between a first frame and at least two second frames, wherein the first frame and the second frames are included in a story-driven game;
in response to and based on a natural language input of one or more non-deterministic rules via the user interface, configuring the transitioning between the first frame and the at least two second frames, wherein the non-deterministic rules are based, at least in part, on a randomly generated number; and
compiling the story-driven game into computer-executable software.

12. The computer-readable medium of claim 11, wherein the actions further comprise causing display of a second user interface for configuring transitioning between one of the second frames and at least one third frame.

13. The computer-readable medium of claim 12, wherein the actions further comprise configuring the transitioning between one of the second frames and at least one third frame based, at least in part, on a deterministic rule, wherein the deterministic rule excludes any randomly generated number.

14. The computer-readable medium of claim 11, wherein the operations further comprise publishing the computer-executable software to a plurality of game marketplaces.

15. The computer-readable medium of claim 14, wherein publishing the computer-executable software to a plurality of game marketplaces is performed in response to a single user interaction.

16. A system comprising:
one or more processors;
a memory configured to store information, which when executed by the one or more processors cause the system to perform a method, the method comprising:
in response to one or more commands from a game creator, configuring a first frame of a story-driven game to incorporate one or more first pieces of multimedia content;
in response to and based on input of the at least one rule without need for code- or script-based programming, configuring the first frame to be connected to at least two second frames; and
compiling the story-driven game into computer-executable software.

17. The system of claim 16, wherein configuring the first frame of the story-driven game to incorporate the one or more first pieces of multimedia content comprises retrieving the one or more first pieces of multimedia content from a network-based data repository.

18. The system of claim 16, wherein the one or more commands include at least one of a search command, classification command, browse command, or preview command.

19. The system of claim 16, wherein configuring the first frame of the story-driven game to incorporate the one or more first pieces of multimedia content comprises requesting candidate multimedia content from one or more content contributors.

20. The system of claim 19, wherein requesting candidate multimedia content comprises providing the one or more content contributors a level of access to at least the first frame.

21. The system of claim 16, wherein the method further comprises sharing revenue generated from the compiled computer-executable software with one or more content creators that provided the one or more first pieces of multimedia content.

22. A computer-implemented method for automatic publication of a story-driven game including a plurality of frames, comprising:
obtaining configuration data for a story-driven game including a plurality of frames, wherein individual frames include one or more pieces of multimedia content and wherein at least a subset of the frames are connected with one another via directed connections;
in response to a single interaction by a game creator with a user interface:
compiling the configuration data into one or more computer-executable games; and
publishing the computer-executable games to one or more game marketplaces.

23. The method of claim 22, wherein the one or more game marketplaces include network-based software or app stores.

24. The method of claim 22, wherein compiling the configuration data into one or more computer-executable games is based, at least in part, on respective specifications and/or standards of the one or more game marketplaces.

25. The method of claim 22, further comprising receiving proceeds from the one or more game marketplaces based, at least in part, on access to the one or more computer-executable games by game players.

26. The method of claim 25, further comprising performing accounting of the received proceeds with respect to at least one or more game creators who constructed the plurality of frames and one or more content contributors who provided the one or more pieces of multimedia content.
